(19) United States
(12) Patent Application Publication
(10) Pub. No.: US 2009/0206989 A1
(43) Pub. Date: Aug. 20, 2009

(54) ELECTRONIC COMMUNICATION SYSTEM, IN PARTICULAR ACCESS CONTROL SYSTEM FOR P(ASSIVE)K(EYLESS)E(NTRY), AS WELL AS METHOD FOR DETECTING A RELAY ATTACK THEREON

(75) Inventor: Adam Leitch, Reigate (GB)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 11/576,462

(22) PCT Filed: Sep. 20, 2005
(86) PCT No.: PCT/IB2005/053091

§ 371 Date: Mar. 11, 2009

(30) Foreign Application Priority Data
Sep. 30, 2004 (EP) 04256041.7

(51) Int. Cl. G08B 29/00

(52) U.S. Cl. 340/5.61

(57) ABSTRACT

In order to provide an electronic communication system (100), in particular an access control system for P[assive]K[eyless]E[ntry], comprising at least one base station (10) being arranged in particular on or in an object to be secured against unauthorized use and/or against unauthorized access, for example being arranged on or in a vehicle and/or on or in an access system, at least one remote device (20), in particular at least one transponder unit, which remote device (20) may in particular be carried with him by an authorized user and/or is designed to exchange data signals (12, 22) with the base station (10), in which case, by means of the data signals (12, 22) the authorization for use and/or for access can be determined and/or the base station (10) can be controlled accordingly, wherein cost and complexity of the remote device (20) are reduced, it is proposed that the remote device (20) comprises at least one recording unit (24) for recording at least part of the data signals (12, 22), in particular for recording at least one first signal (12), being sent by the base station (10), and that the base station (10) comprises at least one processing unit (14) for processing the data signals (12, 22).

The present invention relates in general to the technical field of security systems and/or access systems, and in particular to the technical field of so-called P[assive]K[eyless]E[ntry] systems, such as are used, for example, in the area of means of transport and in this case above all in the area of access systems for motor vehicles.

Specifically, the present invention relates to an electronic communication system as detailed in the preamble of claim 1, and to a method of detecting and/or of guarding against at least one attack, and particularly an external attack and preferably at least one relay attack, on at least one electronic communication system as detailed in the preamble to the claim 1.

Most cars are currently opened by either a key, or by a transmission from a transponder or a key fob, which is initiated by the user when in proximity to the vehicle. Newer generations of cars are starting to use P[assive]K[eyless]E[ntry] systems, in which an initiation by the user is not required; the car simply opens when the user approaches or when the user pulls the car door handle. A further option is the so-called “Keyless Go” method in which the user can start the car without using any key or other access card device. This is possible because the car “knows” that the access card is within the car.

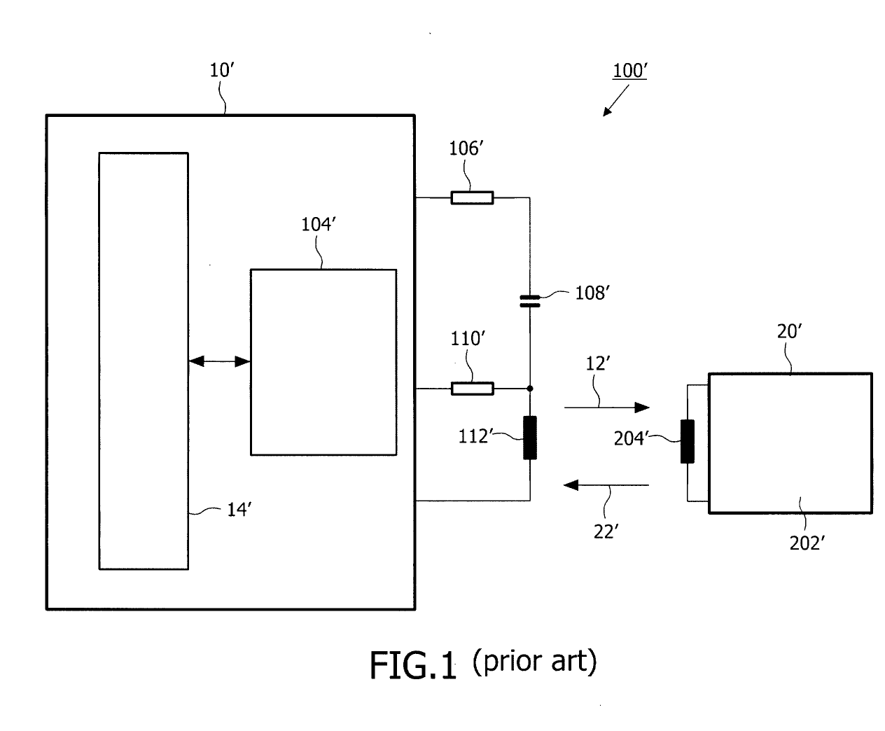

In order to provide electronic communication systems, and particularly P[assive]K[eyless]E[ntry] systems, of the kind specified above that have amongst other things a conventional passive transponder system, use is conventionally made of various configurations. One possible configuration is shown in FIG. 1 of the drawings, the example used being that of a P[assive]K[eyless]E[ntry] system for a motor vehicle:

Between a so-called base station 10′ (internally equipped with an analog interface 104′ and externally equipped with a first resistor 106′, a capacitive unit 108′, a second resistor 110′ and an antenna unit 112′ in the form of a coil) and a remote device 20′, in particular a transponder station, a communication sequence in the form of a data exchange takes place:

In detail, there are, as signal transmission links between the base station 10′ and the remote device 20′,
at least one first signal 12′, in particular a so-called up-link frame, that is formed, for example, by at least one inductively coupled L[ow]F[requency] channel and over which signals are transmitted from the base station 10′ to the remote device 20′, and
at least one second signal 22′, in particular a so-called down-link frame, that is formed, for example, by at least one U[ltra]H[igh]F[requency] channel and over which signals are transmitted from the remote device 20′ to the base station 10′ (as an alternative to this, both the up-link frame 12′ and the down-link frame 22′ may each be formed by at least one L[ow]F[requency] channel or, as an alternative to this in turn, both the up-link frame 12′ and the down-link frame 22′ may each be formed by at least one U[ltra]H[igh]F[requency] channel).

After, for example, the owner 300 approaches or pulls the door handle of the motor vehicle, the base station 10′, which is spatially and functionally associated with the motor vehicle, begins to generate a signal that is referred to as a “challenge” and that is transmitted to the remote device 20′ via the up-link frame 12′.

A processor 202′, in particular a circuit arrangement, in the remote device 20′, which is preferably equipped with at least one microprocessor, then calculates from the challenge, using a cryptographic algorithm and a secret key, a signal sequence that is referred to as a “response”. This response signal is then transmitted from the remote device 20′ to the base station 10′ via the down-link frame 22′.

The base station 10′ then compares the response, using an identical crypto-algorithm and an identical secret key. If identity is found, the base station 10′ causes the door lock of the motor vehicle to open, i. e. only if, generally by using cryptographic methods, the authentication process recognizes the remote device 20′ as valid, in the embodiment given as an example, the door lock of the motor vehicle is opened.

If, however, this circuit arrangement is operated in the form shown in FIG. 1 without any other added technical provisions, there is a danger that an external attacker, who is attempting to open the door of the vehicle without being authorized to do so, may carry out a so-called “relay attack”, as described below, using relatively little in the way of technical resources.

Thus the main problem with P[assive]K[eyless]E[ntry] is the risk of relay attack in which someone in proximity to the car, could forward a signal using a R[adio]F[requency] relay system to another person close enough to transmit to, and listen to transmissions from the remote device 20′, in particular the key fob.

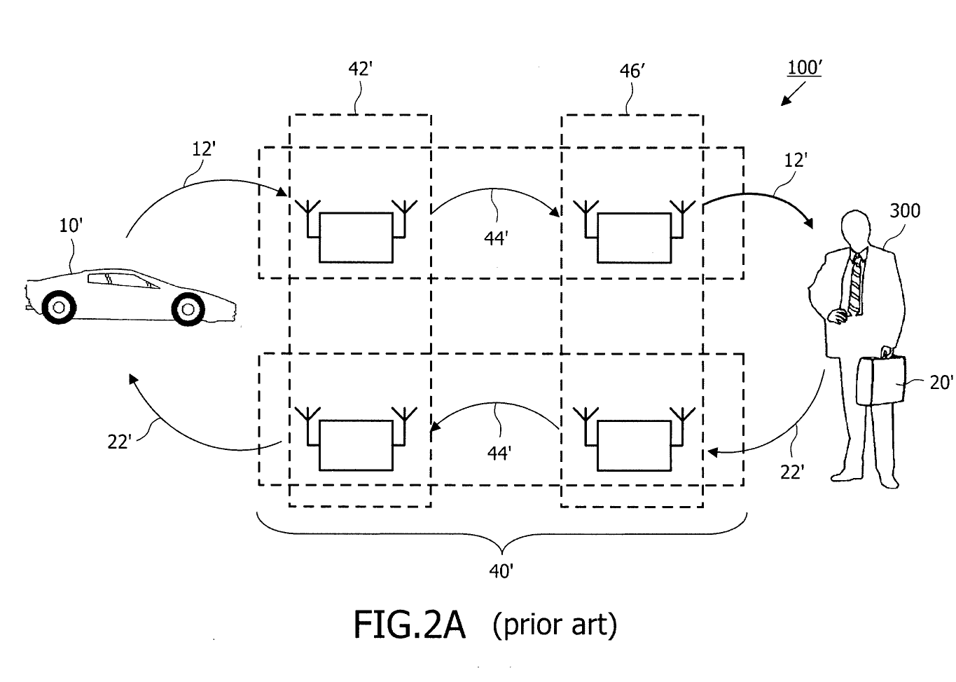

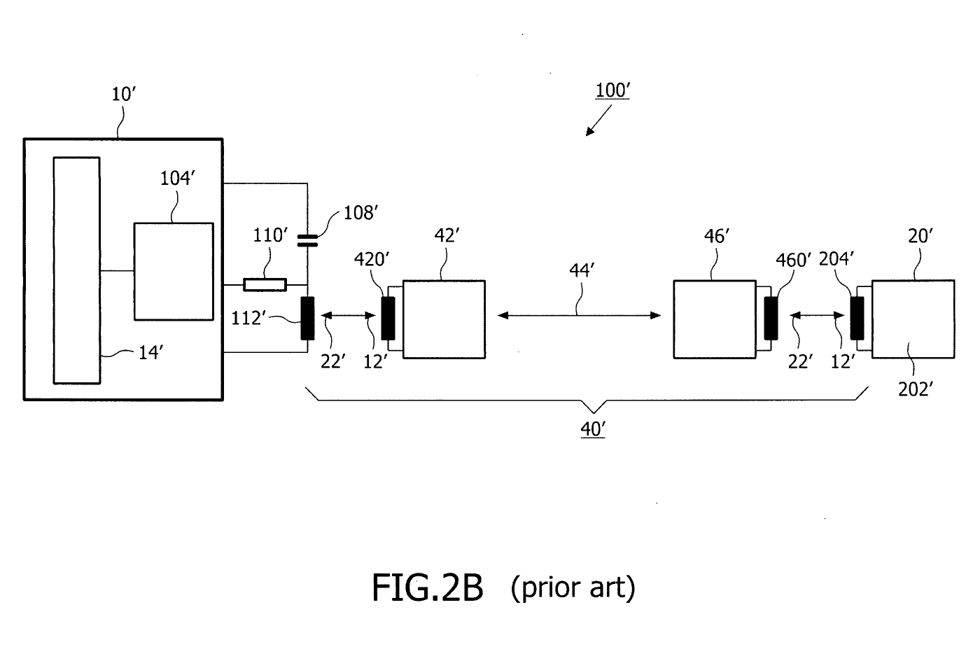

Shown diagrammatically in FIGS. 2A and 2B is an arrangement for carrying out a relay attack of this kind. For this purpose, there is introduced into the configuration shown in FIG. 1 an “attacker kit” in the form of an additional transmission link 40′ that comprises
a first relay 42′ in the form of an emulator for the remote device 20′,
a second relay 46′ in the form of an emulator for the base station 10′, and
a communication link 44′ between the first relay 42′ and the second relay 46′.

To allow inductive coupling to the antenna unit 112′ of the base station 10′, the first relay 42′ in the form of the transponder station emulator is fitted with an associated antenna unit 420′ in the form of a coil; similarly, the second relay 46′ in the form of the base station emulator is fitted with an associated antenna unit 460′ in the form of a coil for inductive coupling to an antenna unit 204′ in coil form of the transponder station 20′.

One attacker then takes up position in the immediate vicinity of the motor vehicle with the first relay 42′. A second attacker positions himself sufficiently close to the valid transponder station 20′ with the second relay 46′. Triggered by, for example, approaching the motor vehicle or pulling the door handle of the motor vehicle, the base station 10′ in the motor vehicle transmits its challenge to the first relay 42′ by means of the original, i. e. unemulated, up-link frame 12′.

From this first relay 42′, the challenge is passed on via the above-mentioned communication link 44′ to the second relay 46′. The second relay 46′emulates the up-link 12′ and in this way passes on the challenge to the valid transponder station 20′ by means of the antenna unit 460′ in coil form.

Once the response has been calculated in the valid transponder station 20′, this transponder station 20′ responds to the second relay 46′ by transmitting this response by means of the original, i. e. non-emulated down-link frame 22′. From this second relay 46′, the response is passed on via the above-mentioned communication link 44′ to the first relay 42′. The first relay 42′ emulates the down-link frame 22′ and in this way passes on the response to the valid base station 10′ in the motor vehicle by means of the antenna unit 112′ in coil form.

Since the response was produced by the authentic transponder station 20′ on the basis of the authentic challenge from the base station 10′ using the correct crypto-algorithm and the correct key, the response is recognized as valid and the door of the motor vehicle opens, even though the authorized and rightful user does not want this.

All in all, the relay attack is formed by two transceivers capable of transmitting the signals from the base station 10′, in particular from the car, and from the remote device 20′, in particular from the key fob, over much longer distances than was intended as depicted in FIG. 2A. This allows the car to be opened even when the owner 300 is many hundreds of meters or further from the car.

In view of the fact that more stringent demands are being made nowadays on the operation and on the security of certain components, precisely in, for example, the area of automobiles and the area of access, the configuration shown in FIG. 1, which can be sabotaged by the measures as shown in FIGS. 2A and 2B, appears not to be sufficiently secure.

Accordingly, certain proposals for detecting and guarding against relay attacks of this kind have already been made in the past. In prior art document EP 1 136 955 A2 for example, there is disclosed an arrangement for an access-safeguarding system (a P[assive]K[eyless]E[ntry] system) by means of which the relative orientation of the base station 10′ and of the transponder station 20′ to one another can be calculated. However, this arrangement is based on using multiple antennas at the car, which leads to additional costs.

Moreover, to prevent relay attack some techniques based on pulse shaping are known. Thus, prior art document US 2003/0043023 A1 discloses a passive response communication system according to which two transponders exchange signals comprising a plurality of anti-relay-attack pulses.

Under another proposal, to allow such relay attacks to be detected and guarded against, the time between the challenge and the response is determined to enable an additional delay due to the delays caused by the electronics of the relays and to the additional transit time of the signals between the relay stations to be detected in this way; this is called the transit-time measurement method.

Using this transit-time measurement method, in particular determining the T[ime]O[f]F[light] of the signals, because of the risk of relay attack allows the exact distance between the key fob 20′ and the car 10′ to be determined. The advantage of this is that it is possible to verify if a relay attack is taking place because the “round trip” time for the signals would be much longer than if the car 10′ and the owner or user 300 with the remote device 20′ are close to each other.

Therefore, several work has been done on detecting relay attacks by measuring the T[ime]O[f]F[light] of the signals. For example, prior art document WO 02/01247 A2 discloses a method based on the use of different frequencies, for measuring the distance between two objects for access control of a motor vehicle.

Furthermore, according to prior art document U.S. Pat. No. 6,396,412 a passive R[adio]F[requency]-R[adio]F[requency] entry system being based on signal strength is disclosed.

A passive remote keyless entry system, based on a plurality of sensors, is disclosed in prior art document U.S. Pat. No. 6,236,333.

Considering the time-of-flight method in prior art document WO 01/25060 A2, a relay attack detection is disclosed that is based almost entirely on measuring delay in change of phase, through changing carrier frequencies.

To overcome relay attack vulnerability, measuring the time of flight—as done in prior art document US 2002/0024460 A1—gives an indication of the distance s between the base station 10′ and the remote device 20′, in particular between the car and the key fob. This requires several messages to be passed between the base station or master 10′, in particular the car, and the remote device or slave unit 20′, in particular the key fob.

In prior art document WO 2004/051581 A1, an electronic communication system as well as a method as described at the beginning is disclosed. According to this prior art document, due to the speed of R[adio]F[requency] signals (one meter in about three nanoseconds), it is essential that correlation is used to verify the T[ime]O[f]A[rrival] to sub-sample accuracy; this in turn gives rise to a computation requirement at either end (base station 10′ and remote device 20′, in particular master unit and slave unit) of the system.

This computation requirement adds cost and complexity to the remote device 20′, in particular to the key fob, whereas the remote device 20′ should ideally be as small as possible, in particular without large batteries; for example, it should be possible to keep the remote device 20′ in a user's wallet or handbag.

Starting from the disadvantages and shortcomings as described above and taking the prior art as discussed into account, an object of the present invention is to further develop an electronic communication system of the kind as described at the beginning, and a method of the kind as described at the beginning, in such way that cost and complexity of the remote device are reduced.

The object of the present invention is achieved by an electronic communication system comprising the features of claim 1, by a remote device comprising the features of claim 4, by a base station comprising the features of claim 5 as well as by a method comprising the features of claim 6. Advantageous embodiments and expedient improvements of the present invention are disclosed in the respective dependent claims.

The present invention relates in general to eliminating processing requirement from the remote device, in particular from the slave, in a time of flight measurement system.

Under the teaching of the present invention
the remote device comprises at least one recording unit for recording at least part of the data signals, in particular for recording at least one first signal, being sent by the base station, and
the base station comprises at least one processing unit for processing the data signals.

In an advantageous embodiment of the present invention, a conventional T[ime]O[f]F[light] system as discussed above with reference to FIGS. 1, 2A, 2B is modified. Specifically, at least one data packet is recorded at the remote device, and instead of processing this data in the remote device, for example by correlation, it is merely recorded against at least one clock unit, in particular against at least one slave clock. Then the data packet is returned to the base station, in particular to the car, in order to perform at least one correlation.

Thus this advantageous embodiment bases on the idea of “moving” the processing requirement (at the expense of additional data transmission). This specifically allows the removal of a processing unit, in particular of a correlator, from the remote device, in particular from the slave device.

According to a particularly inventive refinement of the present invention, the distance between the base station and the remote device can be measured by means of determining the T[ime]O[f]F[light] of at least part of the data signals. The actual measurement of distance from the base station, in particular from the car, to the remote device, in particular to the key fob, is used by the base station to determine for example whether to unlock the doors, and/or to instigate other features, such as for example seat position or height preference, etc.

Thus, the measured distance is utilized only at the base station end; the remote device in most circumstances does not require knowledge of its relative distance to the base station. This can be exploited
by eliminating all signal processing at the remote device end, and
by retransmitting, in particular by forwarding, the data back to the base station for processing.

This leads to the advantages
of lower power consumption at the remote device end, and
of the elimination of a large correlation stage, which is power hungry in a “non-integer chipping rate different clock frequency” setup, needed to obtain sub-sample accuracy.

In an essential embodiment of the present invention, the carrier frequency of at least part of the data signals being (re)transmitted by the remote device can be measured.

Furthermore, according to a preferred embodiment at least one clock rate, in particular at least one clock rate of the remote device, can be determined.

Independently thereof or in connection therewith,
at least part of the data signals and/or
the determined clock rate can be correlated.

The remote station may advantageously be arranged in at least one data carrier, and in particular in at least one key fob or in at least one card, and specifically in at least one chip card.

According to an expedient embodiment of the method of the present invention,
part of the data signals, in particular the first signal, being sent by the base station is recorded against at least one clock unit and/or
the data signals, in particular
the first signal being sent by the base station and
at least one second signal preferably including the retransmission time,

are (re)transmitted to the base station.

Moreover, preferably
the (re)transmitted data signals are received, and/or
the carrier frequency of at least part of the data signals being (re)transmitted by the remote device is measured, and/or
at least one clock rate of the remote device is determined, and/or
at least part of the data signals and/or the determined clock rate of the remote device is correlated by the base station.

The present invention finally relates to the use of at least one electronic communication system as described above and/or of at least one remote device as described above and/or of at least one base station as described above and/or of the method as described above for authenticating and/or for identifying and/or for checking the authority to use, enter or the like an object to be secured by means of the communication system as described above, such as, for example a means of transport and/or an access system.

As already discussed above, there are several options to embody as well as to improve the teaching of the present invention in an advantageous manner. To this aim, reference is made to the claims respectively dependent on claim 1 and on claim 6; further improvements, features and advantages of the present invention are explained below in more detail with reference to a preferred embodiment by way of example and to the accompanying drawings where

FIG. 1 schematically shows an electric circuit diagram of the principle of communication, based on inductive coupling, between a base station and a remote device as in prior art embodiment;

FIG. 2A schematically shows a so-called “relay attack” on the prior art embodiment shown in FIG. 1;

FIG. 2B schematically shows the equivalent electric circuit diagram of the relay attack shown in FIG. 2A;

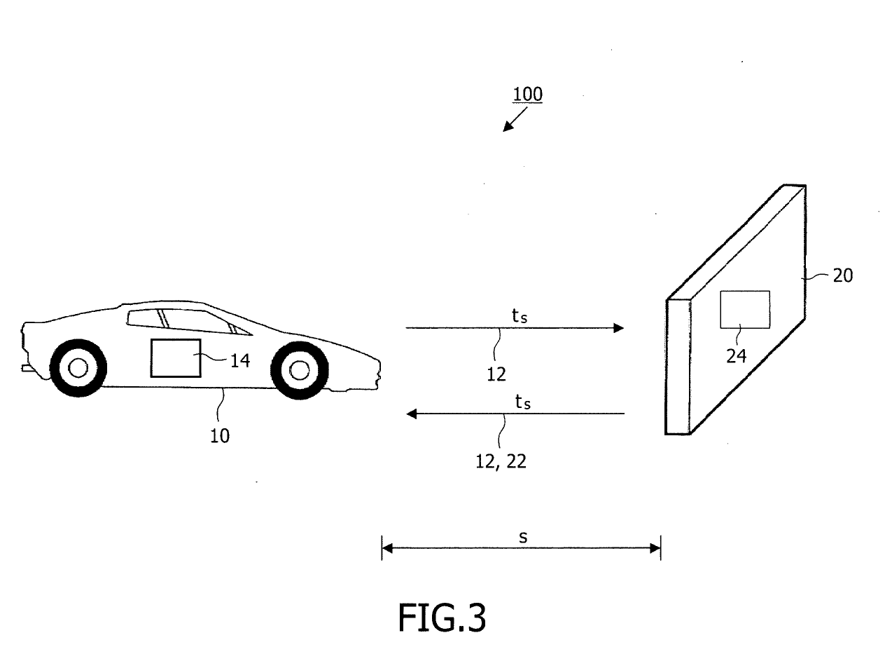

FIG. 3 schematically shows the principle of measurement according to the present invention for detecting relay attacks such as shown in FIGS. 2A and 2B, wherein processing requirement is eliminated from the remote device; and

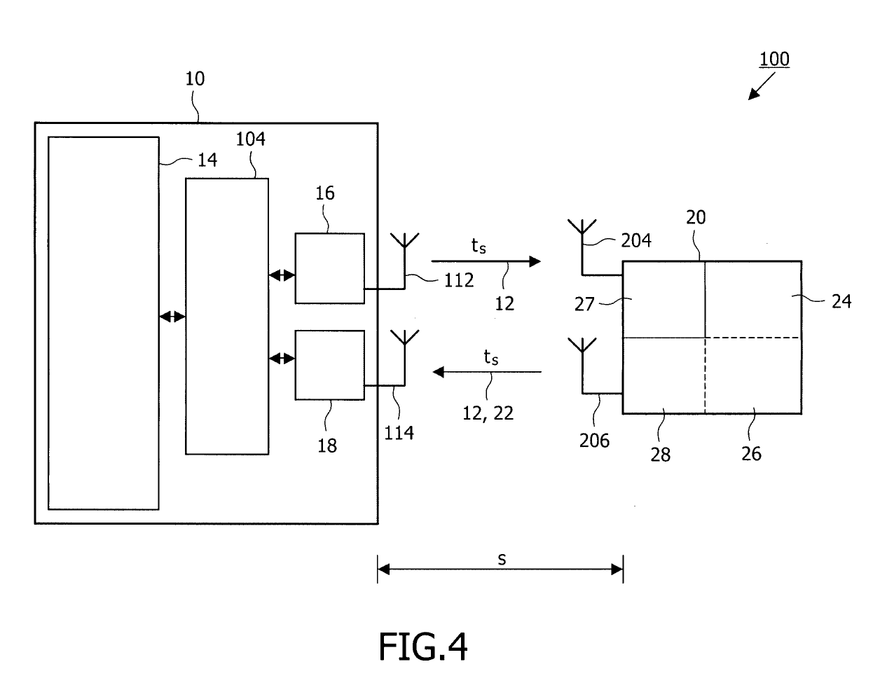

FIG. 4 schematically shows an embodiment of the electric circuit diagram according to the present invention, this electric circuit diagram being equivalent to the principle of measurement shown in FIG. 3.

The same reference numerals are used for corresponding parts in FIGS. 1 to 4.

As shown in FIG. 3, an embodiment, which is implemented by means of the present invention, is an electronic communication system 100 that has, amongst other things, a remote device 20 in form of a data carrier, namely a P[assive]K[eyless]E[ntry] card, which in turn is part of a system for opening and closing the door locks of a motor vehicle.

This electronic communication system 100 is in particular an access control system for P[assive]K[eyless]E[ntry], wherein the access is controlled by determining the distance between a base station or master unit 10 which is arranged in the car and the slave unit or remote device 20 which is part of a key fob. Thus, the electronic communication system 100 bases on a method to obtain a measurement of the so-called time of flight tₛ in a P[assive]K[ey]E[ntry] system for cars.

Between the base station 10 and the remote device 20, a communication sequence in the form of a data exchange takes place. In detail, there are, as signal transmission links between the base station 10 and the remote device 20,
a first signal 12 being transmitted from the base station 10 to the remote device 20 and being retransmitted from the remote device 20 to the base station 10, and
a second signal 22 including a signal transit time and/or a time of retransmission (<——> reference numeral tₛ in FIGS. 3 and 4) and being transmitted from the remote device 20 to the base station 10.

As shown in FIG. 4, for processing the first signal 12 as well as for processing the second signal 22 the base station 10 comprises a processing unit 14. Via an analog interface 104, the processing unit 14 is connected
with a transmitting unit 16 being connected with an externally arranged antenna 112 for transmitting the first signal 12 and
with a receiving unit 18 being connected with an externally arranged antenna 114 for receiving the first signal 12 being retransmitted by the remote device 20 and for receiving the second signal 22 being transmitted by the remote device 20.

The remote device 20 on the other hand comprises
a receiving unit 27 being connected with an externally arranged antenna 204, the receiving unit 27 being designed for receiving the first signal 12,
a recording unit 24 for recording the received first signal 12,
a slave clock unit 26 for providing a clock rate, and
a (re)transmitting unit 28 for retransmitting the first signal 12 and for transmitting the second signal 22, this (re)transmitting unit 28 being connected with an externally arranged antenna 206.

If, for example, the owner carrying with him the key fob with the remote device 20 approaches the car, in particular if the owner passes a predetermined distance of the car, or if the owner pulls the door handle of the car, the remote device 20 wakes and checks for signals 12 from the base station 10, which is spatially and functionally associated with the car. The base station 10 then generates a signal that is referred to the remote device 20 as a “challenge” and that is transmitted to the remote device 20 via the up-link frame 12.

The remote device 20 merely records the data 12 by the recording unit 24 but does not process this data 12; after recording the date 12, the remote device 20 transmits the data 12 back to the base station 10 in the car by a (re)transmission unit 28. Furthermore, the remote device 20 sends the additional second signal 22, including the time of retransmission and/or the signal transit time to the base station 10. This response signal is then transmitted from the remote device 20 to the master unit or base station 10 via the down-link frame 22.

The master unit 10 then measures the time of “retransmission” and determines if the user is within a defined area of the car. Furthermore, the base station 10 compares the response, using an identical crypto-algorithm and an identical secret key. If identity is found and if the signals 12, 22 were sent within a defined area (corresponding to a relatively low re-transmission time), the base station 10 causes the door lock of the motor vehicle to open.

In other words: only
if, generally by using cryptographic methods, the authentication process recognizes the remote device 20 as valid, and
if the authentication process determines the remote device 20 to be within a defined area,

the door lock of the motor vehicle is opened

In the following, an example for the operating method as well as for the use of the electronic communication system according to the present invention is given:

A user approaches his or her car. Intermittently, the key fob wakes and checks for signals; at ten meters from the car, the key fob starts a data recording in its recording unit 24, a few cycles into this, a message 12 from the car is present. The key fob records the data 12, and then initiates a transmission 12, 22 back to the car. This transmission 12, 22 includes the time of “retransmission” and also the data.

The car receives the data and already has prior knowledge of the slave device clock 26. Some of this information about the clock 26 in the receiver 24 is determined by measuring the carrier frequency, and as this is a direct multiple of the sample rate, the clock rate of the receiver 24 can be identified. This information about clock rate, coupled with the received data file 12, 22, allows a correlation to take place.

This happens twice:
firstly, on the data packet from the slave device 20, and
secondly for the re-transmission from the slave device 20.

This means that the master unit 10 has all information to make a measurement of the time of flight tₛ, and thus the master unit 10 determines that the user is within the defined area of the car, and hence unlocks the car door.

As a consequence of the limited amount of electronics in the key fob, this key fob being normally kept in the user's wallet is very slim.

As a result, a technique is suggested to simplify the key fob design and complexity in a P[assive]K[eyless]E[ntry] environment, at the expense of additional loading and power consumption on the car. Given that the master receiver already has a correlator to perform T[ime]O[f]A[rrival] measurements, processing an extra data packet adds almost no additional complexity, apart from small changes to the protocol to allow sending a packet of data between the two devices 10 and 20.

### LIST OF REFERENCE NUMERALS

100 electronic communication system
100′ electronic communication system according to prior art (cf. FIGS. 1, 2A, 2B)
10 base station, in particular main unit, for example car
10′ base station according to prior art (cf. FIGS. 1, 2A, 2B)
12 data signal, in particular first signal, for example up-link-frame, being sent by the base station 10 and/or being retransmitted by the remote device 20
12′ first signal, in particular up-link-frame, according to prior art (cf. FIGS. 1, 2A, 2B)
14 processing unit, in particular control unit, for example microcontroller unit, of the base station 10
14′ processing unit of the base station 10′ according to prior art (cf. FIGS. 1, 2A, 2B)
16 transmission unit of the base station 10
18 receiving unit of the base station 10
20 remote device, in particular transponder station, for example data carrier, more specifically P[assive]K[eyless]E[ntry] card of key fob
20′ remote device, in particular transponder station, for example data carrier, more specifically P[assive]K[eyless]E[ntry] card of key fob, according to prior art (cf. FIGS. 1, 2A, 2B)
22 data signal, in particular second signal, for example down-link-frame, being sent by the remote device 20
22′ second signal, in particular down-link-frame, according to prior art (cf. FIGS. 1, 2A, 2B)
24 recording unit of the remote device 20
26 clock unit, in particular slave clock, of the remote device 20
27 receiving unit of the remote device 20
28 (re)transmission unit of the remote device 20
40′ additional transmission link according to prior art (cf. FIGS. 1, 2A, 2B)
42′ first relay, in particular for first attacker and/or for first thief, forming an emulator for the remote device 20′
44′ communication link between first relay 42′ and second relay 46′
46′ second relay, in particular for second attacker and/or for second thief, forming an emulator for the base station 10′
104 analog interface of base station 10
104′ analog interface of base station 10′
106′ first resistor of base station 10′
108′ capacitive unit of base station 10′
110′ second resistor of base station 10′
112 antenna unit of base station 10 associated with transmission unit 16
112′ antenna unit of base station 10′
114 antenna unit of base station 10 associated with receiving unit 18
202′ processor, in particular circuit arrangement or control unit, for example microcontroller unit, of remote device 20′
204 antenna unit of remote device 20 associated with receiving unit 27
204′ antenna unit of remote device 20′
206 antenna unit of remote device 20 associated with (re)transmission unit 28
300 authorized person, in particular owner and/or user of the electronic communication system 100, 100′
420′ antenna unit of first relay 42′
460′ antenna unit of second relay 46′
s distance between base station 10 and remote device 20
tₛ T[ime]O[f]F[light] of data signals 12, 22 and/or signal transit time between base station 10 and remote device 20

1. An electronic communication system, in particular an access control system for P[assive]K[eyless]E[ntry], comprising
at least one base station being arranged in particular on or in an object to be secured against unauthorized use and/or against unauthorized access, for example being arranged on or in a vehicle and/or on or in an access system,
at least one remote device in particular at least one transponder unit, which remote device
may in particular be carried with him by an authorized user and/or
is designed to exchange data signals with the base station in which case, by means of the data signals
the authorization for use and/or for access can be determined and/or
the base station can be controlled accordingly, characterized in
that the remote device comprises at least one recording unit
for recording at least part of the data signals in particular for recording at least one first signal being sent by the base station and
that the base station comprises at least one processing unit for processing the data signals

2. The electronic communication system according to claim 1, characterized in
that the processing unit designed for determining the distance between the base station and the remote device by means of determining the T[ime]O[flF[light] (t,) of at least part of the data signals and
that the authorization for use and/or for access is determined at least dependent on the determined distance between the base station and the remote device

3. The electronic communication system according claim 1, characterized in that the processing unit designed
for measuring the carrier frequency of at least part of the data signals being (re)transmitted by the remote device and/or
for determining at least one clock rate of the remote device and/or
for correlating
at least part of the data signals and/or
the determined clock rate of the remote device

4. A remote device for an electronic communication system according to claim 1, characterized by
at least one receiving unit for receiving at least part of the data signals in particular for receiving at least one first signal being sent by the base station
at least one recording unit for recording at least part of the data signals in particular for recording at least one sent first signal being sent by the base station
at least one clock unit for providing at least one clock rate,
at least one transmission unit (re)transmitting the data signals in particular
for retransmitting at least one first signal being sent by the base station and
for transmitting at least one second signal to the base station

5. A base station for an electronic communication system according to claim 1, characterized by
at least one transmission unit for transmitting at least part of the data signals in particular at least one first signal to the remote device
at least one receiving unit for receiving the data signals being transmitted by the remote device and
at least one processing unit for processing the data signals

6. A method for detecting and/or for guarding against at least one, in particular external, attack, and preferably at least one relay attack, on at least one electronic communication system according to the preamble of claim 1, characterized in
that at least part of the data signals in particular at least one first signal being sent by the base station is recorded by the
remote device and
that the data signals are processed by the base station

7. The method according to claim 6, characterized in
that part of the data signals in particular the first signal being sent by the base station is recorded against at least one clock unit and/or
that the data signals in particular
the first signal being sent by the base station and
at least one second signal preferably including the retransmission time, are transmitted to the base station.

8. The method according to claim 6, characterized in
that the transmitted data signals are received, and/or
that the carrier frequency of at least part of the data signals being transmitted by the remote device is measured, and/or
that at least one clock rate of the remote device is determined, and/or
that at least part of the data signals and/or the determined clock rate of the remote device is correlated by the base station

9. The method according to claim 6, characterized in
that the distance between the base station and the remote device is determined by means of determining the T[ime]O[flF[light] (t,)of at least part of data signals and
that the authorization for use and/or for access is determined at least dependent on the determined distance between the base station and, the remote device

10. (canceled)
